(19) United States
(12) Patent Application Publication
(10) Pub. No.: US 2025/0251300 A1
(43) Pub. Date: Aug. 7, 2025

(54) CONFIGURABLE SPECTRAL, COLOR AND MTF INTEGRATED TESTER SYSTEM

(71) Applicant: MLOptic Corp, Redmond, WA (US)

(72) Inventor: Pengfei Wu, Bellevue, WA (US)

(21) Appl. No.: 18/928,122

(22) Filed: Oct. 27, 2024

Related U.S. Application Data
(63) Continuation-in-part of application No. 18/433,278, filed on Feb. 5, 2024, now abandoned.

(51) Int. Cl. G01M 11/02

(52) U.S. Cl. CPC G01M 11/0207; G01M 11/0292

(57) ABSTRACT

A configurable integrated spectral, color and image-quality tester system including a first optical channel including a first light path for the traversal of a first band of electromagnetic waves, a second optical channel including a second light path for the traversal of a second band of electromagnetic waves, a dichroic beam combiner for combining the first light path and the second light path to form a third light path, a spectral filter interposed between the first optical channel and the dichroic beam combiner for modifying the first band of electromagnetic waves prior to arriving at the dichroic beam combiner, and a third optical channel for receiving the third light path, the third optical channel including a homogenizing module for homogenizing electromagnetic waves, wherein the first band of electromagnetic waves and the second band of electromagnetic waves are together disposed at wavelengths falling in a range of about 200-2500 nm.

### PRIORITY CLAIM AND RELATED APPLICATIONS

This continuation-in-part application claims the benefit of priority from non-provisional application U.S. Ser. No. 18/433,278 filed Feb. 5, 2024. Said application is incorporated by reference in its entirety.

### BACKGROUND OF THE INVENTION

### 1. The Field of the Invention

The present invention relates to a broad spectral homogenizing module and an integrated tester system. More specifically, the present invention is directed to an efficient and compact homogenizing module and used for configurable spectral, color and image quality measurements.

### 2. Background Art

In order to avoid color distortions in a test application where the spectrum of the electromagnetic waves is disposed at a large frequency range, e.g., from ultraviolet (UV) to infrared (IR), a device useful for ensuring the uniformity of the electromagnetic waves is often required. It can be challenging to ensure the uniformity of electromagnetic waves, especially for high transmitting efficiencies with uniform spatial, spectral and angular distributions. Integrating spheres are commonly used for ensuring uniformity in light outputs. When used with a transmittance test, an integrating sphere can potentially negatively impact the test due to losses imparted by the integrating sphere. Further, due to the large size of an integrating sphere, a tester system or a metrological instrument incorporating such a device would be required to have the space to house the device, taking up valuable equipment and floor space of a test facility. In other instances, fibers are used in attempts to create uniformity in a light output. Fibers, too, suffer from losses in transmittance test results. Yet further, the spatial and spectral uniformity as a result of using such devices, may be unsatisfactory for many applications especially when multiple light sources with broadband spectral ranges are used.

There exists a need for a compact device suitable for creating uniform outputs of configurable or programmable broadband electromagnetic waves without losses suffered, e.g., in conventional devices used for creating such uniform outputs in a tester or equipment for applications or equipment including pump-probes, transient spectral, and temporal dimming measurements as well as spectral activations and detections. There also exists a need for a configurable integrated tester system useful for performing a multitude of optical tests, e.g., spectral, color and Modulation Transfer Function (MTF) tests or measurements on a variety of devices such that the number of separately-available instruments for optical tests can be significantly reduced and the testing throughput for these devices can be improved.

### SUMMARY OF THE INVENTION

In accordance with the present invention, there is provided a configurable integrated tester system including:
(a) a first optical channel including a first light path for the traversal of a first band of electromagnetic waves;
(b) a second optical channel including a second light path for the traversal of a second band of electromagnetic waves;
(c) a dichroic beam combiner for combining the first light path and the second light path to form a third light path;
(d) a switchable spectral filter interposed between the first optical channel and the dichroic beam combiner for modifying the first band of electromagnetic waves prior to arriving at the dichroic beam combiner; and
(e) a third optical channel for receiving the third light path, the third optical channel including a homogenizing module for homogenizing electromagnetic waves, the homogenizing module including:
   (i) a light pipe configured for receiving at least one of the first band of electromagnetic waves and the second band of electromagnetic waves unobstructed at a first end and supplying a homogenized output of at least one of the first band of electromagnetic waves and the second band of electromagnetic waves at a second end, wherein the light pipe is a fused silica light pipe; and
   (ii) a wall including an aperture configured to be disposed in an optical path of the light pipe, the wall separating a first space from a second space, wherein the light pipe is disposed within the first space with the second end of the light pipe disposed adjacent to the aperture, the light pipe optically connected to the second space,
wherein the first band of electromagnetic waves and the second band of electromagnetic waves are together disposed at wavelengths falling in a range of about 200-2500 nm.

In one embodiment, the electromagnetic waves can be ultraviolet (UV), infrared (IR) spectrum, visible light or any combinations thereof. In one embodiment, the configurable integrated tester system further includes at least one lens for focusing the electromagnetic waves onto the first end of the light pipe. In one embodiment, the configurable integrated tester system further includes a lens system for focusing the homogenized output onto a device under test (DUT). In one embodiment, the lens system includes two singlets. In one embodiment, the lens system includes a doublet. In one embodiment, the aperture includes a diameter of about 1 to about 4 mm. In one embodiment, the aperture can be a circular shape, a hexagonal shape, a rectangular shape or an elliptical shape. In one embodiment, the configurable integrated tester system further includes a goniometer configured to control the orientation of a device under test (DUT) in the third light path. In one embodiment, the configurable integrated tester system further includes an XY stage configured to support the goniometer. In one embodiment, the configurable integrated tester system further includes an integrating sphere collection module configured for receiving an output of disposing the homogenized output through a device under test (DUT). In one embodiment, the configurable integrated tester system further includes a lens collection module configured for receiving an output of disposing the homogenized output through a device under test (DUT). In one embodiment, the configurable integrated tester system further includes a Modulation Transfer Function (MTF) imaging camera configured for receiving an output of disposing the homogenized output through a device under test (DUT). In one embodiment, the configurable integrated tester system further includes a first light source configured to output the first band of electromagnetic waves. In one embodiment, the configurable integrated tester system further includes a second light source configured to output the second band of electromagnetic waves.

An object of the present invention is to provide an efficient and compact homogenizing module for optical metrology and applications, e.g., pump-probes, transient spectral measurements, spectral activations and detections as well as temporal dimming testers.

Another object of the present invention is to provide an efficient and compact homogenizing module for providing electromagnetic waves with a high degree of uniformity in a broad spectral range from ultraviolet (UV), visible and infrared (IR).

Another object of the present invention is to provide a tester useful for performing various optical tests on a variety of devices such that precise spectral data can be collected rapidly on these devices and analysis can be performed on the precise spectral data and imaging quality can be evaluated such that spectral time response, chromaticity including white points and Yellow Index, as well as MTF performance can be obtained by configuring light sources, spectra, control timing, target patterns and the use of related software algorithms.

Whereas there may be many embodiments of the present invention, each embodiment may meet one or more of the foregoing recited objects in any combination. It is not intended that each embodiment will necessarily meet each objective. Thus, having broadly outlined the more important features of the present invention in order that the detailed description thereof may be better understood, and that the present contribution to the art may be better appreciated, there are, of course, additional features of the present invention that will be described herein and will form a part of the subject matter of this specification.

### BRIEF DESCRIPTION OF THE DRAWINGS

In order that the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a top perspective view of a system in which a homogenizing module is utilized to produce a uniform light distribution;

FIG. 2 is a partially transparent side view of the system shown in FIG. 1;

FIG. 3 is a top perspective view of an optical path shown in FIG. 1;

FIG. 4 is a side view of an optical path shown in FIG. 1;

FIG. 5 is a diagram highlighting an optical path of FIGS. 1-4 in which a homogenizing module is utilized to produce a uniform light distribution;

FIG. 6 is a diagram highlighting an optical path in which a homogenizing module is utilized to produce a uniform light distribution using a doublet disposed downstream of the homogenizing module instead of the two singlets as shown in FIG. 5;

FIG. 7 is a table depicting the transmittance of electromagnetic waves through a present homogenizing module at various wavelengths collected by a high-speed spectrometer;

FIG. 8 is a graph depicting the transmittance of electromagnetic waves through a present homogenizing module at various wavelengths according to the values shown in FIG. 7;

FIG. 9 is a diagram depicting the optical intensity distribution of electromagnetic waves disposed through a present homogenizing module where the image resolution is 500×500 pixels;

FIG. 10 is a diagram depicting the optical intensity distribution of electromagnetic waves disposed through a present homogenizing module where the image resolution is 500×500 pixels and the intensity is expressed as irradiance;

FIG. 11 is a diagram depicting the optical intensity distribution of electromagnetic waves disposed through a present homogenizing module where the aperture diameter is about 4 mm;

FIG. 12 is a diagram depicting the optical intensity distribution of electromagnetic waves disposed through a present homogenizing module where the aperture diameter is about 3 mm;

FIG. 13 is a diagram depicting the optical intensity distribution of electromagnetic waves disposed through a present homogenizing module where the aperture diameter is about 2 mm;

FIG. 14 is a diagram depicting the optical intensity distribution of electromagnetic waves disposed through a present homogenizing module where the aperture diameter is about 1 mm;

FIG. 15 is a diagram depicting the impact a present homogenizing module has on the transmitted spectra of a light source of an optical system;

FIG. 16 is a top front perspective view of a tester system having a tester chamber within which a homogenizing module as shown in FIGS. 1-6, is disposed;

FIG. 17 is a front perspective of the tester system of FIG. 16;

FIG. 18 is a top left front perspective view of an integrated tester system setup including light sources, high-speed shutters, motorized filter wheels, a homogenizing module, a motion stage system, light collection modules and a position calibration module, etc., which are all disposed in the test chamber of the tester system of FIG. 16;

FIG. 19 is a top right front perspective view of the tester setup of FIG. 18; and

FIG. 20 is a front view of the tester setup of FIG. 18.

### PARTS LIST

2—homogenizing module
4—light pipe, e.g., one made of fused silica
6—aperture
8—input port for long wavelength light path
10—input port for short wavelength light path
12—lens, e.g., coupling aspheric lens made of fused silica
14—imaging aspheric optics, e.g., one made of fused silica
16—imaging aspheric optics, e.g., one made of fused silica
18—prism, e.g., one made of fused silica
20—rotatable polarizer, e.g., ultra broadband polarizer
22—doublet
24—optical output with spectral, spatial and angular uniform distribution
26—device under test (DUT)
28—long wavelength light path
30—short wavelength light path
32—switchable dichroic beam combiner
34—switchable spectral filter
36—optical channel
38—prism module
40—optical channel
42—beam trap
44—first space
46—second space
48—wall
50—calibrated photodetector
52—XY stage
54—common carrier of DUT
56—motorized wheel with six neutral density (ND) filters
58—fused silica aspheric lens system
60—spectrometer, e.g., high-speed spectrometer which can be synchronized with high-speed optical shutters
62—input end of light pipe
64—output end of light pipe
66—configurable integrated tester system
68—light source, e.g., quartz tungsten halogen light source at wavelengths of about 400 nm to about 2500 nm
70—light source, e.g., xenon light source at wavelengths of about 200 nm to about 800 nm
72—test chamber
74—computer and light source controller
76—electronics and motion controller
78—integrating sphere collection module, e.g., for precise spectral collection and analysis
80—lens collection module, e.g., for high-speed spectral collection and analysis
82—Modulation Transfer Function (MTF) imaging camera, e.g., for imaging quality evaluation
84—front surface of light pipe
86—rear surface of light pipe
88—rotation stages
90—location at which DUT is positioned
92—optical channel
94—optical channel

### Particular Advantages of the Invention

The present configurable broad-spectral homogenizing module is compact in its form factor, efficient as its optical path is straightforward, uses a limited number of highly-transparent optical components to achieve broad-band spectral uniformity and the present homogenizing module imparts no significant losses as in the case of fibers or integrating spheres, which may be used to produce uniform light sources. Further, the size of integrating spheres presents significant spatial limitations that render them impractical for use with some applications with spatial limitations. The present homogenizing module works by guiding electromagnetic waves, e.g., light, through multiple reflections within a light pipe, causing mixing and averaging of the input light without significant losses. Combined with an adjustable aperture, the present homogenizing module allows only a highly uniform light distribution to be produced at the output end of the homogenizing module.

During the research and development phase of a new device or material, scientists and engineers often require data that is as complete as possible to understand the physics of a device under test (DUT) and to address any engineering issues during this phase. As multiple measurement features can be made available simultaneously using the present tester in a single system, a DUT does not need to be set up repeatedly for different instruments in order for various measurements to be obtained. More importantly, for some special devices, e.g., dimming devices, or materials of which the spectral, e.g., transmittance, spatial and polarization characteristics, MTF, Yellow Index, and haze characteristics, can be changed under certain conditions, e.g., under the application of certain electrical voltage or light illumination, having a tester capable of providing the required measurements all in a single system, allows required measurements to be obtained in a single setting without the need to recreate certain optical conditions across multiple separately-available testers to allow corresponding data to be collected and analyzed. The present tester not only allows data collection to be performed effectively and rapidly but also reduces the potential for data collection errors to be introduced and reduces the possibility that tests will need to be repeated if data collection is flawed.

### DETAILED DESCRIPTION OF A PREFERRED EMBODIMENT

The term “about” is used herein to mean approximately, roughly, around, or in the region of. When the term “about” is used in conjunction with a numerical range, it modifies that range by extending the boundaries above and below the numerical values set forth. In general, the term “about” is used herein to modify a numerical value above and below the stated value by a variance of 20 percent up or down (higher or lower).

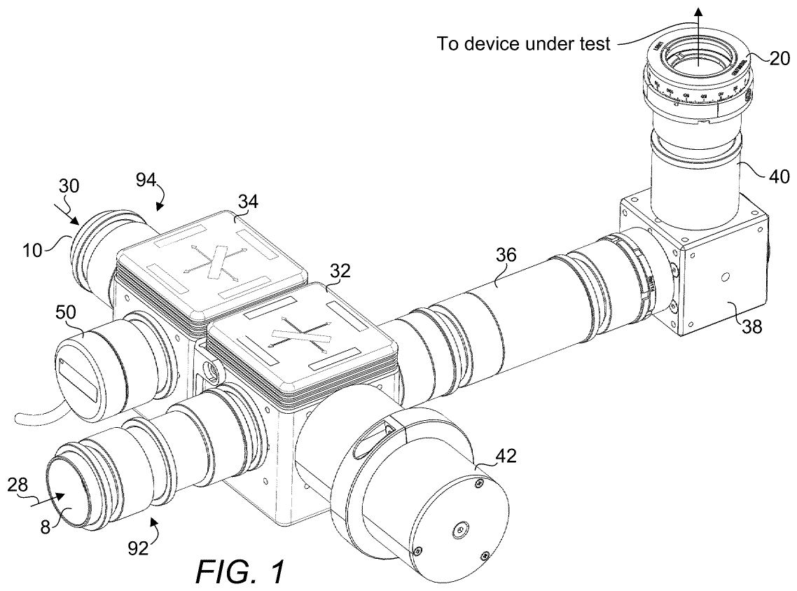

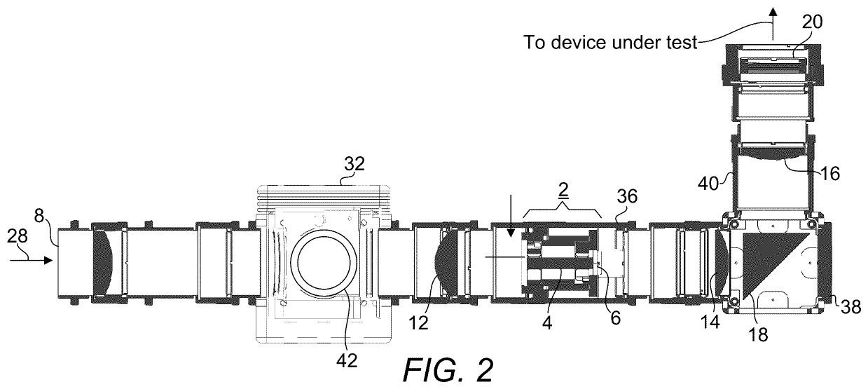

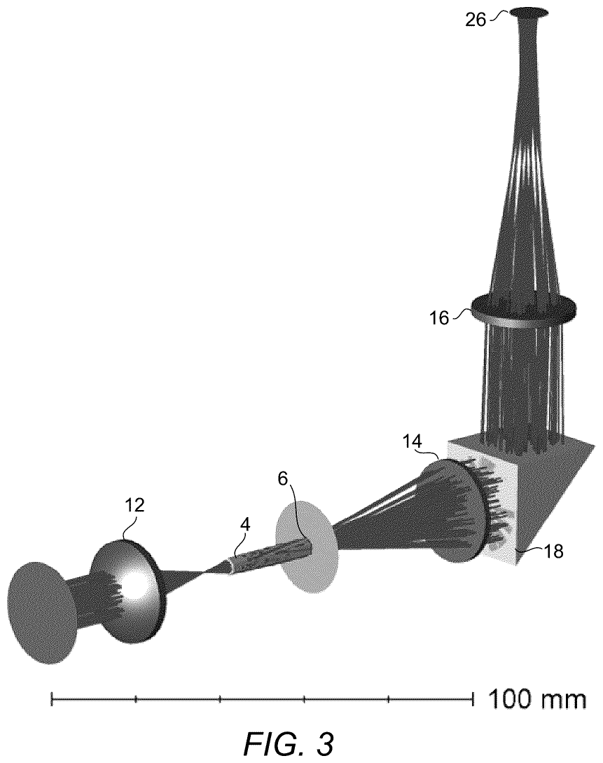

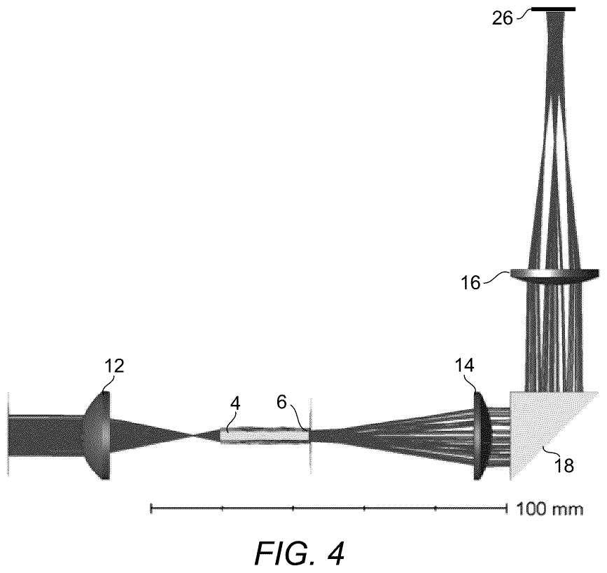

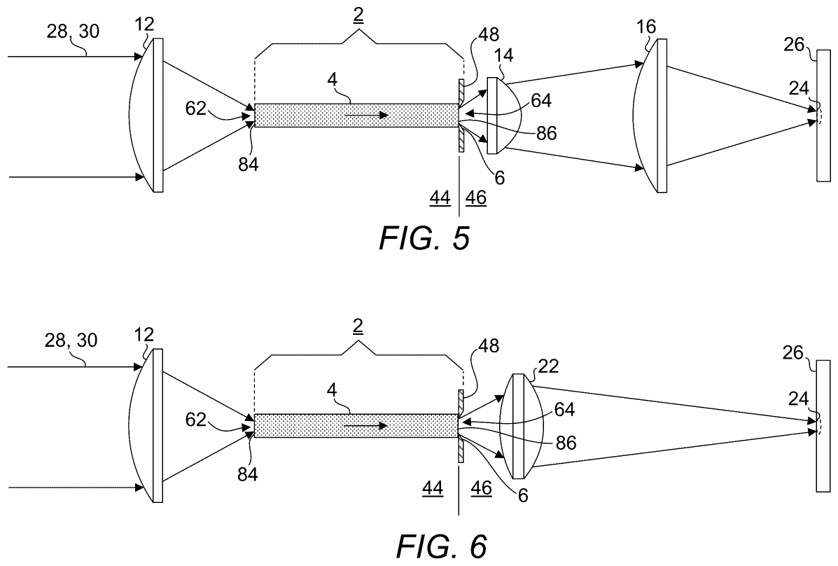

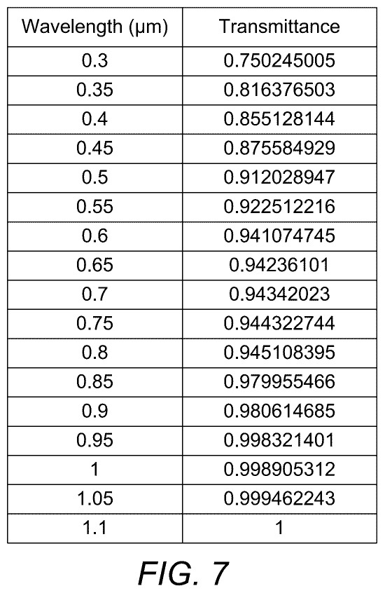

FIG. 1 is a top perspective view of a system in which a homogenizing module 2 is utilized to produce a uniform light distribution. FIG. 2 is a partially transparent side view of the system shown in FIG. 1. FIG. 3 is a top perspective view of an optical path shown in FIG. 1 without showing the rotatable polarizer 20. FIG. 4 is a side view of an optical path shown in FIG. 1, again without showing the rotatable polarizer 20. FIG. 5 is a diagram highlighting an optical path of FIGS. 1-4 in which a homogenizing module 2 is utilized to produce a uniform light distribution. Referring to FIG. 1, the homogenizing module 2 and the imaging lens or optics 14 disposed within optical channel 36 while the imaging lens or optics 16 is disposed within optical channel 40. Prism 18 is disposed within prism module 38. FIG. 6 is a diagram highlighting an optical path in which a homogenizing module is utilized to produce a uniform light distribution using a doublet 22 disposed downstream of the homogenizing module instead of the two singlets 14, 16 as shown in FIG. 5. The homogenizing module 2 is suitable for homogenizing electromagnetic waves disposed in a wavelength of about 200 to about 2000 nm and it includes a light pipe 4 and a wall 48 including an aperture 6. The light pipe 4 is configured for receiving electromagnetic waves at a first end of the light pipe 4 and supplying a homogenized output of the electromagnetic waves at a second end of the light pipe 4. The wall is useful for blocking electromagnetic waves and it only allows the electromagnetic waves to traverse via the aperture 6 configured to be disposed in an optical path of the light pipe 4. The wall serves to optically separate a first space 44 from a second space 46 in an optical path, where the light pipe 4 is disposed within the first space 44 with the second end of the light pipe disposed adjacent to the aperture 6. The light pipe 4 is optically connected to the second space 46. The present homogenizing module 2 is suitable for homogenizing electromagnetic waves received through an input port 8 of a light path 28 configured for receiving electromagnetic waves of long wavelengths, e.g., visible light and/or infrared (IR) spectrum and an input port 10 of a light path 30 configured for receiving electromagnetic waves of short wavelengths, e.g., ultraviolet (UV) light. Therefore, in the examples shown in FIGS. 1-6, the electromagnetic waves received at the homogenizing module 2 can be electromagnetic waves composed of at least two bands of electromagnetic waves, e.g., UV and visible light or UV and IR, disposed through at least two different individually-controllable light paths 28, 30. A dichroic beam combiner 32, e.g., a switchable dichroic beam combiner, is used to combine the inputs through the two paths 28, 30 to form a unified input to the homogenizing module 2. Each band of the electromagnetic waves may also be used without being combined with other bands. When a single band is desired, only the light path conveying the electromagnetic waves of the desired band is allowed through the light path, e.g., by way of an open shutter, or the electromagnetic waves of the desired band being activated. In one embodiment, the electromagnetic waves are electromagnetic waves disposed through at least one spectral filter 34. This filter may be replaced with another suitable filter to block electromagnetic waves of certain undesired wavelengths from arriving at a device under test (DUT) or to simulate a variety of spectra, e.g., spectra found in a solar simulator. In general, the present homogenizing module is further useful for homogenizing electromagnetic waves traversing one or more of the light paths shown in FIG. 1 or any additional light paths either simultaneously or alternatingly to result in an output useful for a pump-probe, a system useful for taking transient spectral and temporal dimming measurements as well as a system in which spectral activations and detections are involved. Each of the dichroic beam combiner 32 and the spectral filter 34, is precisely and magnetically-localized and locked such that it can be quickly removed, reinstalled or replaced with a similar device. In one example, the spectral filter 34 is switchable to another spectral filter as the spectral filter 34 can be replaced with another spectral filter appropriate for a specific or different spectral range in a new test. The ability to switch the spectral filter 34 is important since many applications require unique light spectra and a switchable spectral filter 34 allows the light source spectra to be modified or programmed to be specific shapes to meet those applications. For instance, a Yellow Index measurement requires a D65 light source, a visor testing requires a sun light simulator, a UV-activated dimming device requires a specific UV light spectrum that photosensitive materials are sensitive to, a pump-probe experiment requires an activation, i.e., pump, light source in one spectral range while a probe light requires a different spectral range.

In the examples shown in FIGS. 1-6, the homogenizing module 2 may include a lens 12, e.g., a coupling aspheric lens made of fused silica for focusing the electromagnetic waves onto the first end of the light pipe 4. In the embodiment shown in FIGS. 1-5, the homogenizing module further includes a lens system 14, 16 for focusing the homogenized output onto a DUT disposed in the optical path of the homogenized output, i.e., the lens system includes two singlets 14, 16. Upon passing through a singlet 14, the electromagnetic waves are directed by a prism 18, e.g., one made of fused silica, in a direction that is disposed at about 90 degrees to the incoming waves to pass through another singlet 16 before arriving at a rotatable polarizer 20 interposed between imaging lenses 14, 16 and a DUT, as shown in FIGS. 1-6 or a DUT as shown in FIG. 5. Electromagnetic waves enter the light pipe 4 unobstructed as there is not an apertured wall disposed on the input end 62 of the light pipe 4 such that any incoming electromagnetic waves to the light pipe 4 would not be blocked or redirected, i.e., the front surface 84 of the light pipe 4 is unobscured. The light pipe 4, as well as other optical components of the light paths shown throughout herein, are constructed with the optical components supported or held in metal optical channels 36, which can also help reduce any thermal effects when full power is used on the two light sources 68, 70. A wall with an aperture of specific patterns can be placed at the output end 64 of the light pipe 4 for unique applications, e.g., Modulation Transfer Function (MTF) measurements. Note that a wall 48 with an aperture 6 is disposed adjacent to the rear surface 86 of the light pipe 4 where the light energy distribution is spatially uniform. In the example shown in FIG. 6, the lens system includes a doublet 22 with incoming rays again cast as an optical output 24 upon a DUT 26. In one embodiment, the aperture 6 includes a diameter of about 1 to about 4 mm. In one example, the light pipe used herein is a hexagonal optics which allows an aperture of size up to about 4 mm in diameter. In one example, after passing through the imaging lenses 14, 16 or 22, the homogenizing module forms a uniform optical spot on the DUT with a diameter from about 2 mm to about 8 mm, i.e., 2× amplification of the aperture diameter, a size suitable for use on a DUT related to extended reality (XR) applications and a size that matches a human eye pupil. Other spot sizes may be formed on a DUT by changing the imaging amplification of the rays traversing the aperture. For many other applications, especially spectral measurements, 3-5 mm diameter spot sizes are normally preferred to obtain localized spectral information due to the limited size of the samples. For large samples, a larger area may be scanned using a small light spot to obtain detailed spatial spectral information.

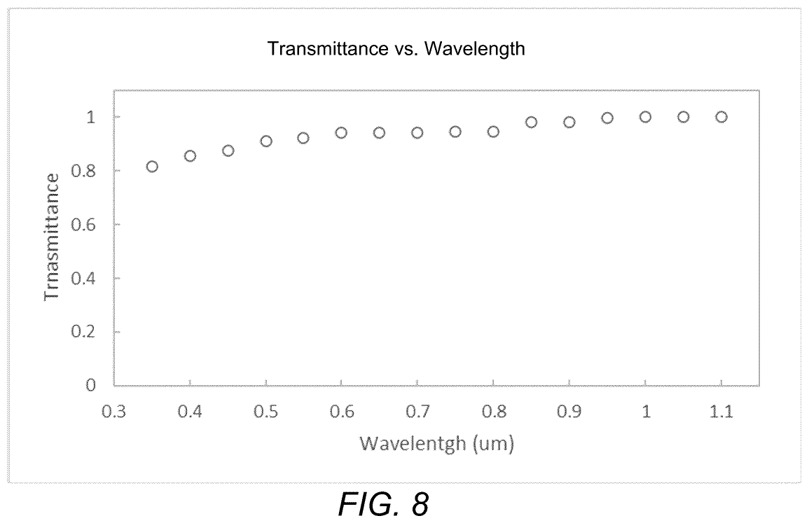

FIG. 7 is a table depicting the transmittance of electromagnetic waves through a present homogenizing module at various wavelengths collected by a high-speed spectrometer. FIG. 8 is a graph depicting the transmittance of electromagnetic waves through a present homogenizing module at various wavelengths according to the values shown in FIG. 7. It shall be noted that the transmittance is slightly lower than an ideal value in the ultraviolet (UV) spectral range, but this may easily be corrected. In one embodiment, the spectral intensity distribution through the homogenizing module is monitored such that deviations in spectral transmittance, chromaticity or luminance can be corrected prior to the homogenized output arriving at a DUT in which spectral data is measured.

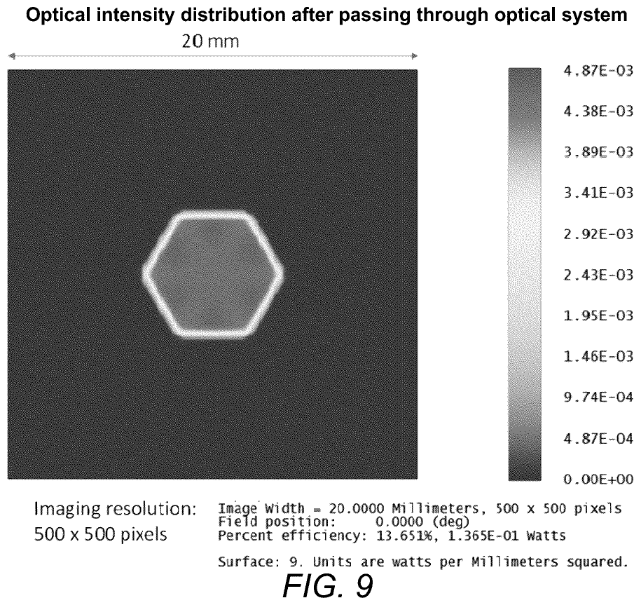

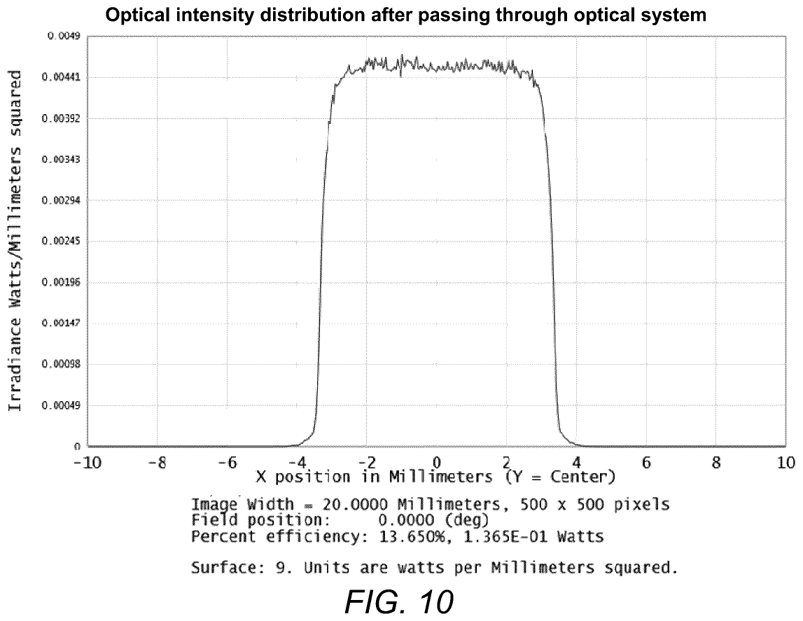

FIG. 9 is a diagram depicting the optical intensity distribution of electromagnetic waves disposed through a present homogenizing module where the image resolution is 500×500 pixels. FIG. 10 is a diagram depicting the optical intensity distribution of electromagnetic waves disposed through a present homogenizing module where the image resolution is 500×500 pixels and the intensity is expressed as irradiance. It shall be noted that the circular aperture is precisely aligned in the center of the hexagonal shape of the optical beam from the light pipe 4.

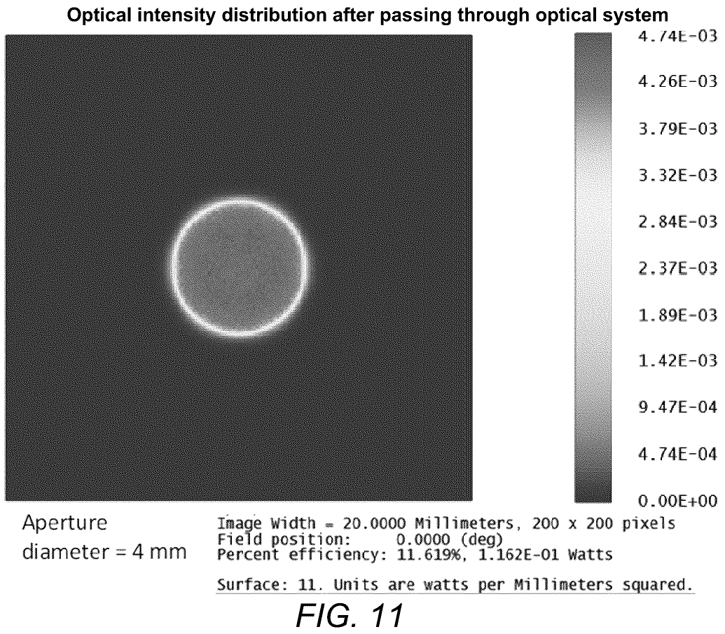

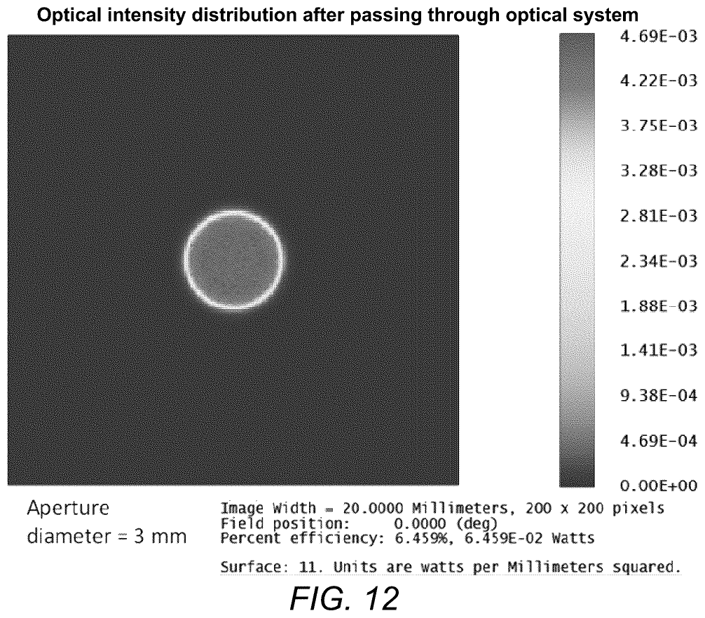

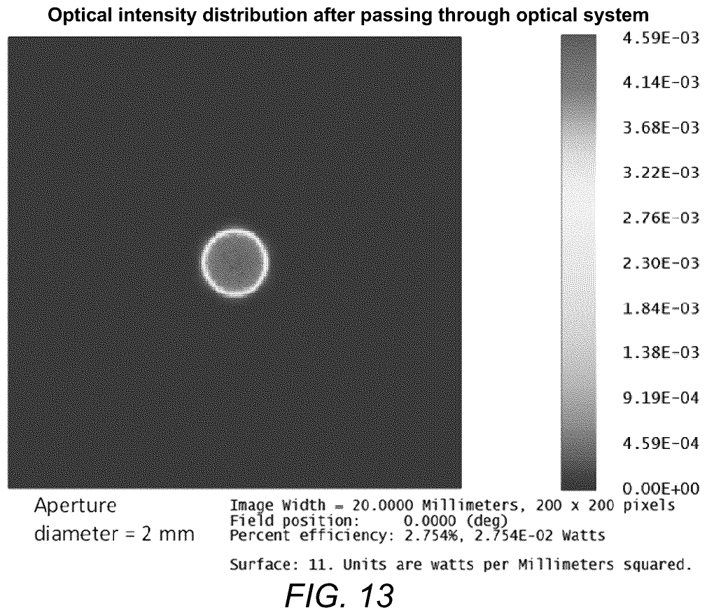

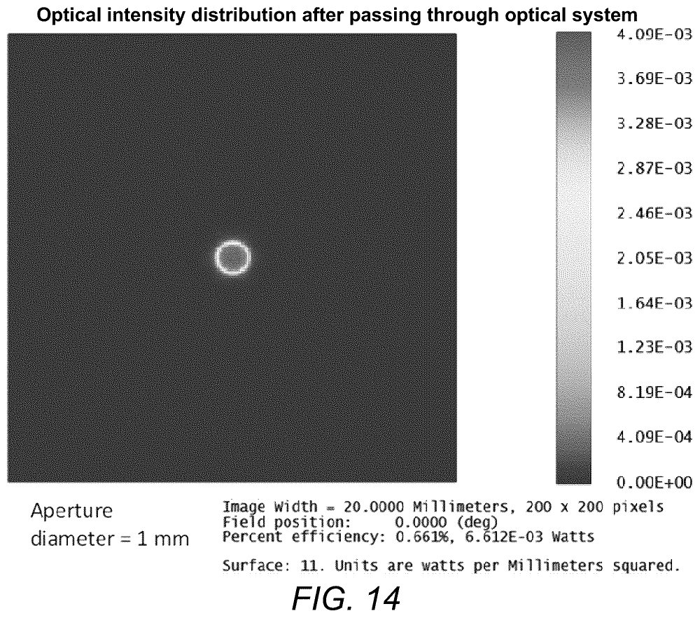

Different aperture sizes, e.g., about 1-4 mm of circular apertures, and shapes, e.g., circular, hexagonal, rectangular and elliptical, etc., are required for various applications and DUTs, e.g., a tester system utilizing a present homogenizing module may scan a large area of a DUT for uniformity testing with different resolution requirements. An adjustable or replaceable aperture, e.g., an aperture shown throughout herein, can be added behind the fused-silica homogenizing optics. FIG. 11 is a diagram depicting the optical intensity distribution of electromagnetic waves disposed through a present homogenizing module where the aperture diameter is about 4 mm. FIG. 12 is a diagram depicting the optical intensity distribution of electromagnetic waves disposed through a present homogenizing module where the aperture diameter is about 3 mm. FIG. 13 is a diagram depicting the optical intensity distribution of electromagnetic waves disposed through a present homogenizing module where the aperture diameter is about 2 mm. FIG. 14 is a diagram depicting the optical intensity distribution of electromagnetic waves disposed through a present homogenizing module where the aperture diameter is about 1 mm.

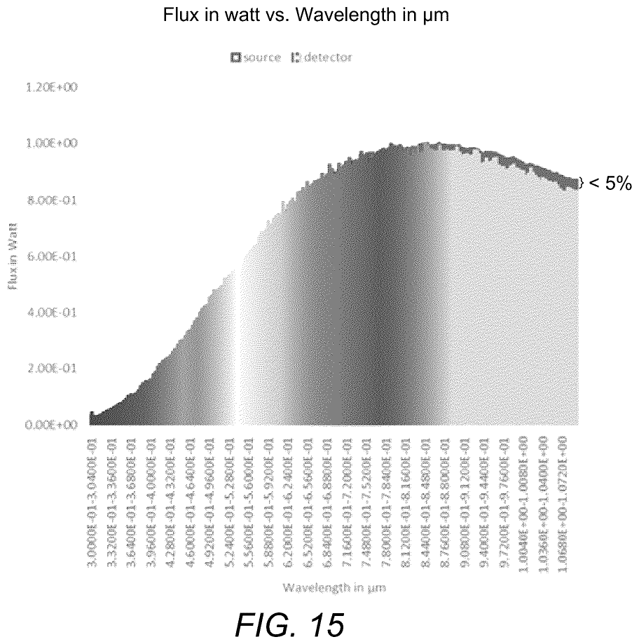

FIG. 15 is a diagram depicting the impact a present homogenizing module has on the transmitted spectra of a light source of an optical system. In this example, the light source used is a quartz tungsten halogen lamp, e.g., 3400K black body, which has a spectrum covering UV, visible light and IR. It shall be noted that the present homogenizing module imparts a small impact on the transmitted spectra of the light source, i.e., less than 5% of flux variation, demonstrating the suitability of a present homogenizing module in transmittance measurements. Such small impact may be corrected using spectral calibrations and will not have any impact on the spectral transmittance, chromaticity and luminance measurements.

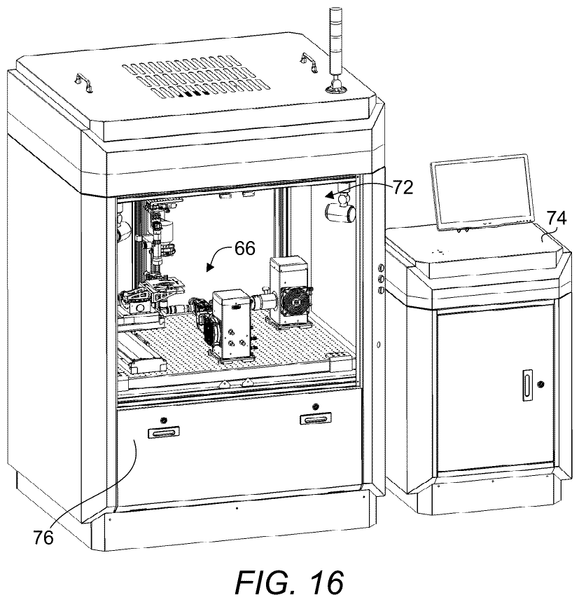

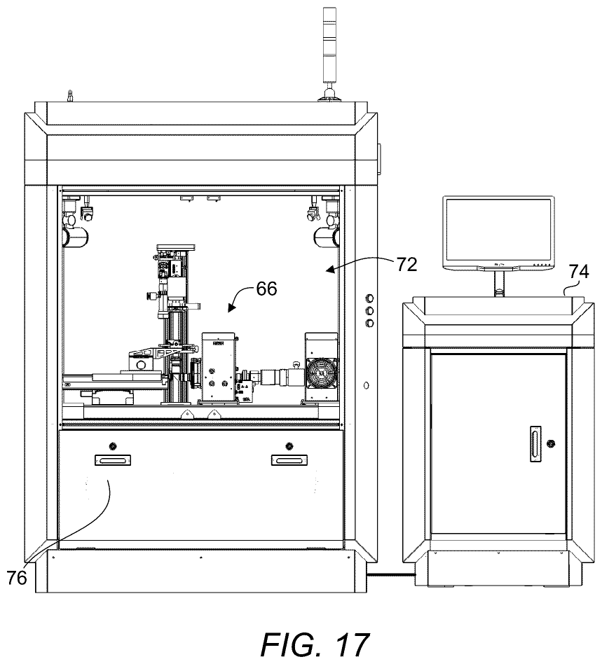

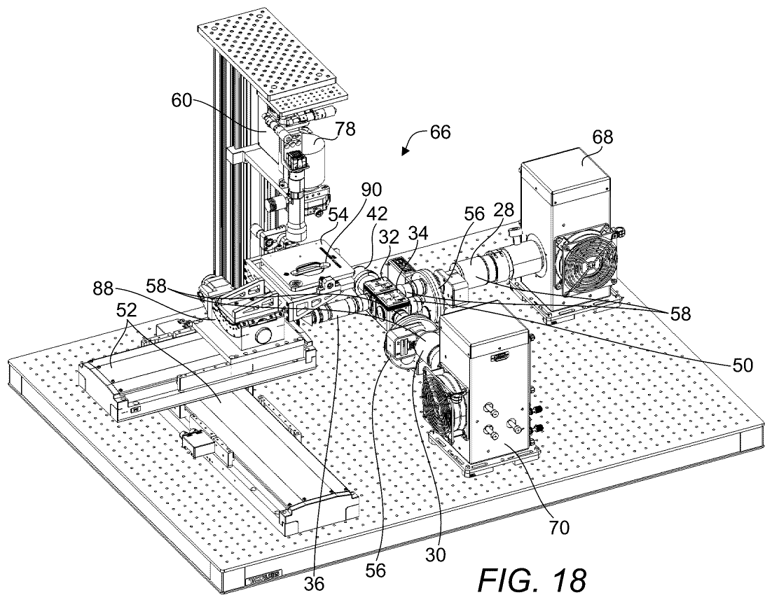

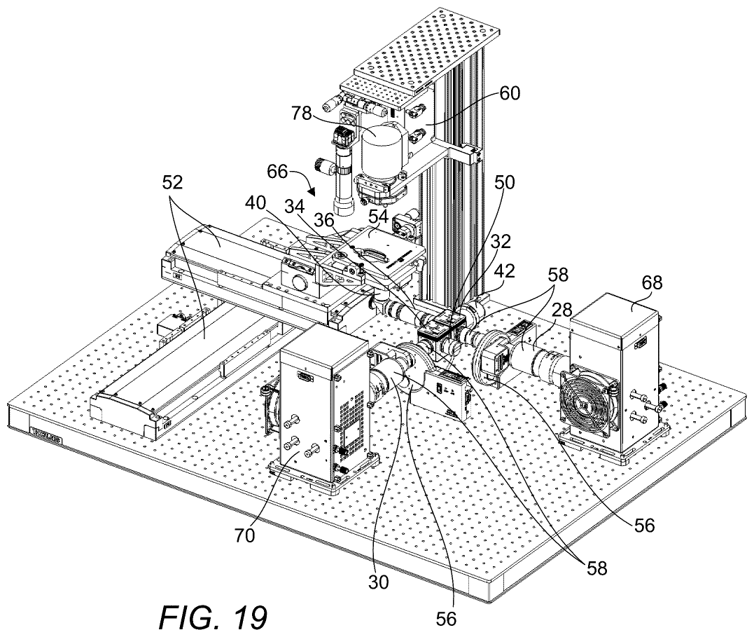

FIG. 16 is a top front perspective view of a tester 66 having a tester chamber 72 within which a homogenizing module as shown in FIGS. 1-6, is disposed, along with other functional modules and devices including light sources, light collection modules, beam control devices, motion stages as well as calibration and imaging modules, etc. FIG. 17 is a front perspective of the tester system of FIG. 16. The optical paths of the tester system 66 are essentially housed in a tester chamber 72 disposed in a top portion of the tester system 66. Electronics and a motion controller 76 that are functionally connected to the tester system 66 are housed below the tester chamber 72. A computer and a light source controller 74 that are also functionally connected to the tester 66 are disposed in a free-standing cabinet next to the cabinet. FIG. 18 is a top left front perspective view of the homogenizing module as used in a tester setup disposed in the test chamber of the tester system 66 of FIG. 16. FIG. 19 is a top right front perspective view of the tester setup of FIG. 18. The tester includes a first optical channel, a second optical channel, a switchable dichroic beam combiner 32, a switchable spectral filter 34, a third optical channel 36 and a wall 48 including an aperture 6, a reticle, a slant edge, a checkerboard or other optical test patterns, placed at the output end, i.e., rear surface of the light pipe 4 of the homogenizing module. The first optical channel 92 includes a first light path 28 for the traversal of a first band of electromagnetic waves emitted from light source 68. The second optical channel 94 includes a second light path 30 for the traversal of a second band of electromagnetic waves emitted from light source 70. The switchable dichroic beam combiner 32 is useful for combining the first light path 28 and the second light path 30 to form a third light path. The switchable spectral filter 34 is interposed between the first optical channel and the switchable dichroic beam combiner 32 for modifying the first band of electromagnetic waves prior to arriving at the switchable dichroic beam combiner 32. The third optical channel 36 is useful for receiving the third light path, the third optical channel 36 including a homogenizing module for homogenizing electromagnetic waves. The homogenizing module includes a light pipe configured for receiving at least one of the first band of electromagnetic waves and the second band of electromagnetic waves unobstructed at a first end 62 and supplying a homogenized output of at least one of the first band of electromagnetic waves and the second band of electromagnetic waves at a second end 64, wherein the light pipe is a fused silica light pipe. The wall 48 includes an aperture 6 or other test targets, e.g., a reticle, a checkboard or a slant edge, etc., configured to be disposed in an optical path of the light pipe 4, the wall separating a first space from a second space. The light pipe 4 is disposed within the first space with the second end 64 of the light pipe 4 disposed adjacent to the aperture 6. The light pipe 4 is optically connected to the second space. As there are two light paths in the tester, the light path connected to light source 68 is configured to receive light with wavelengths disposed in a first range and the light path connected to light source 70 is configured to receive light with wavelengths disposed in a second range which may be significantly different from the first range. Therefore, together, the first band of electromagnetic waves and the second band of electromagnetic waves are disposed at wavelengths falling in a broad range of about 200-2500 nm. The homogenized light disposed through optical channel 40 is directed to location 90 at which a DUT is positioned or interposed within the path of the homogenized light. In one embodiment, an integrating sphere collection module 78, useful for precise spectral collections and analyses, is disposed on one end of the tester for receiving the homogenized light which passed through a DUT disposed at location 90. A lens collection module 80 useful for high-speed spectral collections and analyses may be used in place of the integrating sphere collection module 78 to receive the homogenized light which passed through the DUT. The integrating sphere collection module 78 may alternatively be replaced with a Modulation Transfer Function (MTF) imaging camera 82 useful for imaging quality evaluations. In the present tester, as there is only one port for light collection, only one module 78, 80 or 82 can be mounted at the port, depending on the applications, e.g., high spectral accuracy, high speed, or MTF imaging applications. Location 90 is essentially a portion of an output plate of the common carrier 54 of the DUT where the tip and tilt of the output plate can be controlled using a goniometer, allowing a DUT mounted on the common carrier of the DUT to be disposed in a desired orientation. The position of the DUT is controlled using the XY stage 52 to which the common carrier 54 of the DUT is mounted. As such, the tester system is useful for taking both spatial and angular-dependent measurements in addition to time-dependent measurements.

In one example, the present tester includes multiple measurement features using a single system. A broad light spectrum of about 200 nm-2500 nm can be generated by the two light sources 68, 70. Each light source 68, 70 may be used or turned on singly to provide the range of desired electromagnetic waves or both light sources 68, 70 may be turned on simultaneously to simulate a broad spectrum. In one embodiment, a 1-ms transition measurement of transmittance for a single wavelength or any spectral range of about 200 nm-1100 nm, can be performed. This spectral range is limited by the use of a high-speed and high-resolution spectrometer 60. In another embodiment in which another spectrometer is used, the tester would be capable of detecting any spectra ranging from about 200 nm to 2500 nm. Other measurements include spatial, angular, and spectral uniformity measurements by two-dimensional (2D) scanning, tip/tilt angular spectral measurements, configurable polarized spectral measurements, yellow index and Whiteness measurements, haze measurements, Modulation Transfer Function (MTF) measurements, e.g., by placing a target in a probe beam and replacing the integrating sphere with a camera. The present configurable tester is further capable of measuring different DUTs including electrically-driven dimming devices or samples, e.g., electrochromic, photosensitive films or materials. A spectrometer, as used herein, is a device useful for collecting both static and transient spectral data which can be used to determine many properties of a DUT, e.g., spectral and time responses, chromaticity or color, luminance, whiteness, and Yellow Index, etc. The spectrometer is also synchronized with high-speed optical shutters as well as driving signals in spectral timing and activation control of tests of electrochromic DUTs.

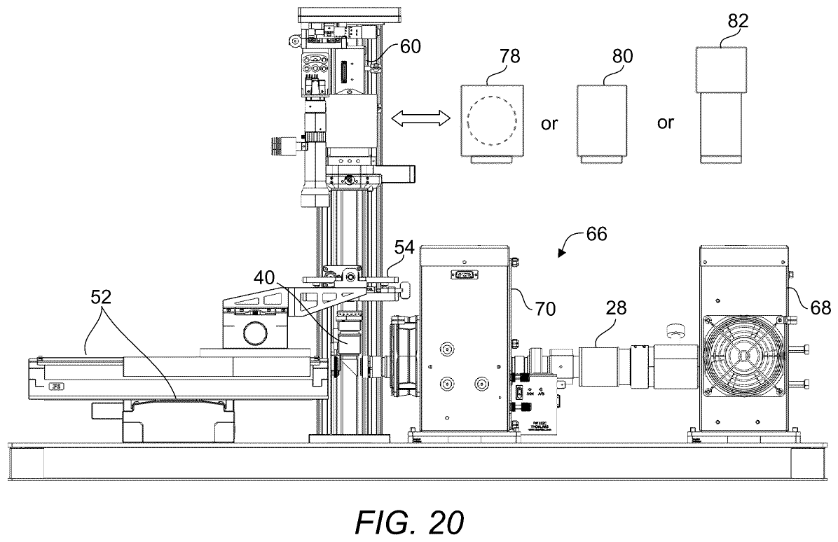

The present tester includes a spectrometer 60 useful for measuring, among other properties, wavelength of light, absorbance and transmittance, emission spectra, reflectance, fluorescence, energy levels of molecules, Raman Scattering, chemical concentration, colorimetry, and optical density. FIG. 20 is a front view of the tester setup of FIG. 18. In one embodiment, the present tester further includes an integrating sphere collection module 78 useful for precise spectral collections and analyses. In another embodiment, instead of using an integrating sphere collection module 78, a lens collection module 80 useful for high-speed spectral collections and analyses is used. Further, in yet another embodiment, an integrating sphere collection module 78 may alternatively be replaced with a Modulation Transfer Function (MTF) imaging camera 82 useful for imaging quality evaluations. In one example, before taking measurements of a DUT for a spectral transmittance test, the DUT is first loaded at common carrier 54 of the DUT. A door of the test chamber 72 is subsequently closed to ensure that a test that is in progress, is not interrupted. The light sources 68, 70 and ambient light such that dark background spectral data can be measured. A light source 68 or 70 is then turned on to measure reference spectral data without the DUT. The DUT is then moved to a location on the common carrier 54 of the DUT and supported or secured using a holder with the region of interest (ROI) of the DUT disposed in the beam center. Transmitted spectral data through the DUT can then be collected and spectral transmittance of the DUT can then be calculated. In some tests when UV light is desired, light source 70 is turned on simultaneously with light source 68. A calibrated photodetector 50 disposed along the light path of light source 70 is used to ensure that a correct amount of UV light power is actually disposed through the light path when light source 70 is turned on. Adjustments to test parameters may include the intensity of a light source 68, 70, motorized ND filters and sensor integrating time adjustments. With a lens collection module 80, various static and temporal or transition spectral data can be collected for a single wavelength or an averaged spectral range. Further, spatial and spectral uniformity measurements can be collected by two-dimensionally scanning a device under test (DUT) with the XY motorized stage 52. Angular spectral measurements can be obtained using the tip and tilt features of the common carrier 54 of the DUT and rotation stages 88. Polarized spectral measurements can be taken by changing the probe and activation polarization states manually or electro-optically using polarization rotation devices. Further, electrically-induced spectral changes can be observed by configuring a wave function of electric signals to drive dimming devices or the DUT. Measurements for Yellow Index can be made by setting light source 70 or light source 68 with appropriate spectral filters disposed in the switchable dichroic beam combiner 32 to D65. Haze measurements can be made by driving the DUT to a position underneath the integrating sphere by following standard haze measurement procedures. If MTF measurements are desired, an MTF camera 82 is used in place of a lens collection module 80 or an integrating sphere collection module 78. Individually, each optical device of the present tester provides only limited data and information about the DUT, e.g., a device including an optical component or a material.

The detailed description refers to the accompanying drawings that show, by way of illustration, specific aspects and embodiments in which the present disclosed embodiments may be practiced. These embodiments are described in sufficient detail to enable those skilled in the art to practice aspects of the present invention. Other embodiments may be utilized, and changes may be made without departing from the scope of the disclosed embodiments. The various embodiments can be combined with one or more other embodiments to form new embodiments. The detailed description is, therefore, not to be taken in a limiting sense, and the scope of the present invention is defined only by the appended claims, with the full scope of equivalents to which they may be entitled. It will be appreciated by those of ordinary skill in the art that any arrangement that is calculated to achieve the same purpose may be substituted for the specific embodiments shown. This application is intended to cover any adaptations or variations of embodiments of the present invention. It is to be understood that the above description is intended to be illustrative, and not restrictive, and that the phraseology or terminology employed herein is for the purpose of description and not of limitation. Combinations of the above embodiments and other embodiments will be apparent to those of skill in the art upon studying the above description. The scope of the present disclosed embodiments includes any other applications in which embodiments of the above structures and fabrication methods are used. The scope of the embodiments should be determined with reference to the appended claims, along with the full scope of equivalents to which such claims are entitled.

1. A configurable integrated tester system comprising:
(a) a first optical channel comprising a first light path for the traversal of a first band of electromagnetic waves;
(b) a second optical channel comprising a second light path for the traversal of a second band of electromagnetic waves;
(c) a dichroic beam combiner for combining said first light path and said second light path to form a third light path;
(d) a switchable spectral filter interposed between said first optical channel and said dichroic beam combiner for modifying said first band of electromagnetic waves prior to arriving at said dichroic beam combiner; and
(e) a third optical channel for receiving said third light path, said third optical channel comprising a homogenizing module for homogenizing electromagnetic waves, said homogenizing module comprising:
(i) a light pipe configured for receiving at least one of said first band of electromagnetic waves and said second band of electromagnetic waves in which said first band of electromagnetic waves and said second band of electromagnetic waves are permitted to propagate without redirection at a first end of said light pipe before supplying a homogenized output of at least one of said first band of electromagnetic waves and said second band of electromagnetic waves at a second end, wherein said light pipe is a fused silica light pipe; and
(ii) a wall comprising an aperture configured to be disposed in an optical path of said light pipe, said wall separating a first space from a second space, wherein said light pipe is disposed within said first space with said second end of said light pipe disposed adjacent to said aperture, said light pipe optically connected to said second space,
wherein said first band of electromagnetic waves and said second band of electromagnetic waves are together disposed at wavelengths of a band of about 2300 nm.

2. The configurable integrated tester system of claim 1, wherein the electromagnetic waves are waves selected from the group consisting of ultraviolet (UV), infrared (IR) spectrum, visible light and any combinations thereof.

3. The configurable integrated tester system of claim 1, further comprising at least one lens for focusing the electromagnetic waves onto said first end of said light pipe.

4. The configurable integrated tester system of claim 1, further comprising a lens system for focusing the homogenized output onto a device under test (DUT).

5. The configurable integrated tester system of claim 4, wherein said lens system comprises two aspheric singlets.

6. The configurable integrated tester system of claim 4, wherein said lens system comprises a doublet.

7. The configurable integrated tester system of claim 1, wherein said aperture comprises a diameter of about 1 to about 4 mm.

8. The configurable integrated tester system of claim 1, wherein said aperture is configured in a shape selected from the group consisting of a circular shape, a hexagonal shape, a rectangular shape and an elliptical shape.

9. The configurable integrated tester system of claim 1, further comprising a goniometer configured to control the orientation of a device under test (DUT) in said third light path.

10. The configurable integrated tester system of claim 9, further comprising an XY stage configured to support said goniometer.

11. The configurable integrated tester system of claim 1, further comprising an integrating sphere collection module configured for receiving an output as a result of disposing said homogenized output through a device under test (DUT).

12. The configurable integrated tester system of claim 1, further comprising a lens collection module configured for receiving an output as a result of disposing said homogenized output through a device under test (DUT).

13. The configurable integrated tester system of claim 1, further comprising a Modulation Transfer Function (MTF) imaging camera configured for receiving an output as a result of disposing said homogenized output through a device under test (DUT).

14. The configurable integrated tester system of claim 1, further comprising a first light source configured to output said first band of electromagnetic waves.

15. The configurable integrated tester system of claim 1, further comprising a second light source configured to output said second band of electromagnetic waves.
